(19) United States
(12) Patent Application Publication
(10) Pub. No.: US 2009/0199686 A1
(43) Pub. Date: Aug. 13, 2009

(54) Apparatus for sawing with self-clamping of work piece

(76) Inventor: Bruce Grachal, Post Falls, ID (US)

Correspondence Address: Gregory IPL, P.C., 601 W. Main, Suite 904, SPOKANE, WA, 99201-3825, US

(21) Appl. No.: 12/069,345

(22) Filed: Feb. 8, 2008

(51) Int. Cl. B26D 1/00; B27B 11/02; B25B 5/00

(52) U.S. Cl. 83/13; 83/821; 269/86

(57) ABSTRACT

An apparatus for clamping a work piece to be cut using a power saw includes a first clamping portion foldably connected with a second clamping portion. The work piece is placed between the first and second clamping portions and the saw is forced against one of the clamping portions to secure the work piece for cutting.

### TECHNICAL FIELD

The technical field of the inventions relate to apparatus and methods for cutting work pieces such as lumber using power saws.

### BACKGROUND OF THE INVENTION

Hand-held circular saws are generally known as efficient, economical and time saving tools for cutting various types of material such as wood, metal, and even concrete and ceramics. Such saws find wide spread appeal, and are used by nearly everyone from the occasional do-it-yourselfer to the professional craftsman. Hand-held circular power saws are particularly well suited for lumber cutting applications, such as cutting studs and other boards.

In such applications, the work piece is usually marked with a pencil line or scribe line to indicate the desired length or width. Then, the saw operator generally employs the marked line and eyes the action of the saw to cut the work piece. That is, the saw operator visually aligns the marking with either a sight device on the saw, or with the saw blade itself when making the cut.

This visual alignment method can also be used when cutting large sheet material or when ripping boards or the like. However, a major drawback of the hand-held circular power saw is that it is generally not well suited for making long, accurate and/or straight cuts, such as in the case of cutting large sheets or when ripping. Specifically, even the best attempts at making long cuts with a hand-held circular power saw using a visual alignment method, as mentioned above, usually result in wavy and/or inaccurate cuts.

Some or all of the problems explained above and other problems may be helped or solved by the inventions shown and described herein. Such inventions may also be used to address other problems not set out above or which are developed at a later time. The future may also bring to light unknown benefits which may be in the future appreciated from the novel inventions shown and described herein.

### BRIEF DESCRIPTION OF THE DRAWINGS

Preferred forms, configurations, embodiments and/or diagrams relating to and helping to describe preferred versions of the inventions are explained and characterized herein, often with reference to the accompanying drawings. The drawings and all features shown therein also serve as part of the disclosure of the inventions of the current application whether described in text or merely by graphical disclosure alone. Such drawings are briefly described below.

FIG. 1 is an isometric view of an apparatus in accordance with a first embodiment of the disclosure.

FIG. 2 is a side view of the apparatus depicted in FIG. 1.

FIG. 3 is another side view of the apparatus depicted in FIG. 1.

FIG. 4 is a partial rear view of the apparatus depicted in FIG. 1.

FIG. 5 is another partial rear view of the apparatus depicted in FIG. 1.

FIG. 6 is an isometric view of an apparatus in accordance with a second embodiment of the disclosure.

FIG. 7 is a top view of the apparatus depicted in FIG. 6, showing the apparatus in a closed position.

FIG. 8 is a top view of the apparatus depicted in FIG. 6, showing the apparatus in an open position.

FIG. 9 is a detail view of FIG. 8.

### DETAILED DESCRIPTION OF THE PREFERRED EMBODIMENTS

### Table Listing Subsections of Detailed Description

A table of subsections for the detail description is below.

Table of Subsections

Table Listing Subsections of Detailed Description
Introductory Notes
General Features and Use
General Configuration
First Clamping Portion
Second Clamping Portion
Guide and Guide Surface
Bearing Surface
Foldable Nature of Apparatus
Variable Spacing Feature of Apparatus
Foldable Connection
Additional Embodiment
Reference Markings
Methods Concerning Manner of Use
Interpretation Notes

### Introductory Notes

The readers of this document should understand that the embodiments described herein may rely on terminology used in any section of this document and other terms readily apparent from the drawings and the language common therefor as may be known in a particular art and such as known or indicated and provided by dictionaries. Dictionaries were used in the preparation of this document. Widely known and used in the preparation hereof are Webster's Third New International Dictionary (© 1993), The Oxford English Dictionary (Second Edition, ©1989), and The New Century Dictionary (©2001-2005), all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms with one embodiment that may also apply to other embodiments for similar structures, functions, features and aspects of the invention. Wording used in the claims is also descriptive of the invention and the text of both claims and abstract is incorporated by reference into the description entirely in the form as originally filed. Terminology used with one, some or all embodiments may be used for describing and defining the technology and exclusive rights associated herewith.

The readers of this document should further understand that the embodiments described herein may rely on terminology and features used in any section or embodiment shown in this document and other terms readily apparent from the drawings and language common or proper therefor. This document is premised upon using one or more terms or features shown in one embodiment that may also apply to or be combined with other embodiments for similar structures, functions, features and aspects of the invention and provide additional embodiments of the inventions.

### General Features and Use

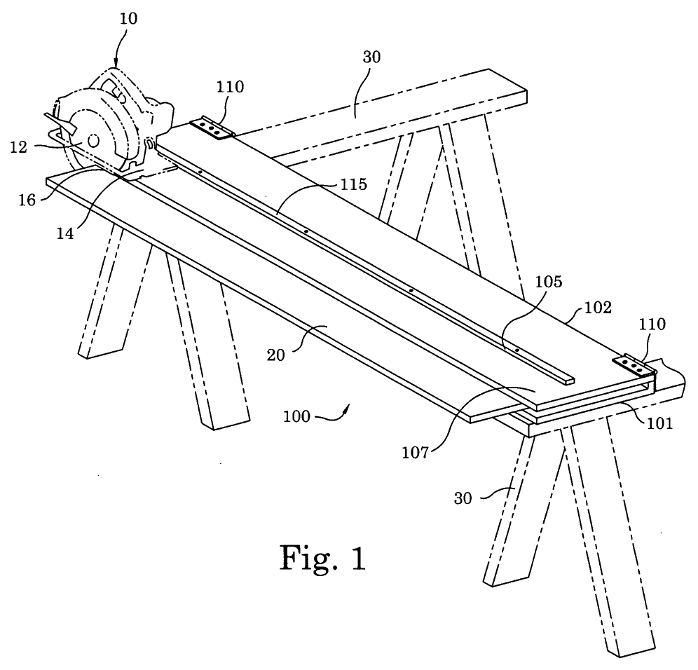

FIG. 1 is a perspective view in which an apparatus 100 is depicted in accordance with one embodiment of the disclosure. The apparatus 100 is intended to be used for securing or clamping a work piece 20 while it is cut or sawn with a saw 10, which can be in the form of a power saw as depicted. The apparatus 100 is also intended to provide guidance for the saw 10 while cutting the work piece 20 so as to enable a substantially accurate and/or straight cut line 16.

The saw 10 can be of the hand-held type, as illustratively depicted, which can be operated by a saw operator (not shown). By way of further example, the saw 10 can be a circular power saw as depicted. However, it is to be understood that the apparatus 100 may possibly be used with a saw having any of a number of other possible configurations that are not specifically depicted. These may include but are not limited to a hand held reciprocating saw such as a jig saw. In accordance with an alternative embodiment, the saw 10 can be a self-cutting or hands-off type saw. The saw 10 can include a cutting blade 12. The saw 10 can also include a base plate 14 or similar feature and/or surface by which the saw is intended to be supported during cutting.

The apparatus 100 can be supported by any suitable base/support 30 such as, but not limited to, a pair of saw horses, as depicted. Other suitable forms of the base/support 30 not depicted include those of a table or a pickup truck tailgate for example. The apparatus 100 can be attached or connected to the base/support 30 by way of suitable attachment means (not shown) such as fasteners, clamps, and the like.

The work piece 20 can be in the form of a plate or sheet of substantially rigid material that is to be cut with the saw 10. By way of example only, the work piece 20 can be a sheet or length of lumber, plywood, particle board, oriented strand board (“OSB”), sheet rock, cement board, corrugated steel, aluminum plate, plexiglass sheet, ceramic tile, vinyl, or the like. The work piece 20 can have other forms not specifically described or depicted.

### General Configuration

Still referring to FIG. 1, the apparatus 100 includes a first clamping portion 101 and a second clamping portion 102. The first clamping portion 101 is joined with the second clamping portion 102 by way of at least one foldable connection 110. That is, the first clamping portion 101 and the second clamping portion 102 are connected in a manner that enables them to be folded relative to one another. In accordance with one embodiment of the disclosure, the foldable connection is in the form of a hinge, as is depicted. By way of example, the apparatus 100 can include a pair of foldable connections 110, each in the form of a hinge as shown.

As is seen from a study of FIG. 1, the apparatus 100 is configured such that the work piece 20 can be clamped or secured between the first clamping portion 101 and the second clamping portion 102. A clamping force can be provided to secure the work piece 20 between the first clamping portion 101 and the second clamping portion 102. The clamping force can be provided by the weight of the saw 10 and/or the weight of the upper clamping portion 102 acting upon the work piece 20. Additional clamping force can be provided by the saw operator pushing down against the saw and/or against the apparatus, as is discussed in greater detail herein below. Typically, however, no substantial downward force is required to be exerted by the operator when using preferred forms of the invention.

### First Clamping Portion

With reference to FIGS. 1-3, the apparatus 100 includes a first clamping portion 101. The first clamping portion 101 can be fabricated from any suitable material. By way of example, the first clamping portion 101 can be fabricated from a material that is substantially rigid. By way of further example, the first clamping portion 101 can be fabricated from wood or wood products such as a solid board or heavy plywood, or it can be fabricated from metal such as aluminum plate. Alternatively, for example, the first clamping portion 101 can be fabricated, at least partially, from any of a number of synthetic materials including, but not limited to, polymers and the like. The first clamping portion 101 can include various braces and/or stiffeners that are not specifically depicted.

The first clamping portion 101 can have a substantially elongated rectangular shape, as depicted. However, it is to be understood that the first clamping portion 101 can have any of a number of specific shapes, contours or forms not specifically depicted herein. By way of example, the first clamping portion 101 can have a particular shape and/or contour that is generally suited to the shape of the work piece 20 to be cut. The first element 101 can include a spacing portion 103 that serves to provide spacing between the first clamping portion and the second clamping portion 102. The spacing portion 103 can be integral with the first clamping portion 101 and/or second clamping portion 102. Alternatively, the spacing portion 103 can be a separate component.

A first contact surface 111 can be defined on the first clamping portion 101. The first contact surface 111 is intended to contact the work piece 20 when the work piece is secured between the first clamping portion 101 and the second clamping portion 102. The first contact surface 111 can be substantially flat, as is depicted. However, it is to be understood that the first contact surface 111 can have any of a number of shapes and/or contours not specifically depicted herein. It is to be further understood that the first contact surface 111 can have any of a number of additional aspects, such as various gripping features and the like, that are not specifically depicted herein. By way of example, the first contact surface 111 can include a gripping material such as rubber or the like and/or can include one or more ridged or knurled surfaces for gripping the work piece 20.

### Second Clamping Portion

Still referring to FIGS. 1-3, the apparatus 100 includes a second clamping portion 102. The second clamping portion 102 can share at least some similarities with the first clamping portion 101, as is apparent from a study of the drawing figures. Specifically, the second clamping portion 102 can be fabricated from any suitable material. By way of example, the second clamping portion 102 can be fabricated from a material that is substantially rigid. By way of further example, the second clamping portion 102 can be fabricated from wood or wood products such as a solid board or heavy plywood, or it can be fabricated from metal such as aluminum plate. Alternatively, for example, the second clamping portion 102 can be fabricated, at least partially, from any of a number of synthetic materials including, but not limited to, polymers and the like. The first clamping portion 101 can include various braces and/or stiffeners that are not specifically depicted.

The second clamping portion 102 can have a substantially rectangular shape, as depicted. However, it is to be understood that the second clamping portion 102 can be chosen from other suitable shapes or forms not specifically depicted herein. A second contact surface 112 can be defined on the second clamping portion 102. The second contact surface 112 is intended to contact the work piece 20 when the work piece is secured between the first clamping portion 101 and the second clamping portion 102. The second contact surface 112 can be substantially flat, as is depicted. However, it is to be understood that the second contact surface 112 can have any of a number of shapes and/or contours not specifically depicted herein.

It is to be further understood that the second contact surface 112 can have any of a number of additional aspects, such as various gripping features and the like, that are not specifically depicted or discussed herein. By way of example, the second contact surface 112 can include a gripping material such as rubber or the like and/or can include one or more ridged or knurled surfaces for gripping the work piece 20. Moreover, the second clamping portion 102 can include one or more of a guide 115, a guide surface 105, and a bearing surface 107, all of which are described in greater detail below.

### Guide and Guide Surface

With continued reference to FIGS. 1-3, the apparatus 100 can include a guide 115. A guide surface 105 can be defined on the guide 115. The guide 115 and/or guide surface 105 are intended to provide cutting guidance for the saw 10 as described herein above. More specifically, the saw 10 can be urged against the guide 115 and/or guide surface 105 while cutting the work piece 20. Accordingly, a saw operator can urge the saw 10 against the guide 115 and/or guide surface 105 so as to cause the saw 10 to follow the guide and/or guide surface while the work piece 20 is being cut with the saw. In this manner, a substantially straight and/or accurate cut of the work piece 20 can be produced.

Although the guide 115 and guide surface 105 are specifically depicted as being straight, it is to be understood that the guide and/or guide surface can have any of a number of other possible shapes and/or profiles and/or contours including, but not limited to curved, arcuate, or elliptical so as to produce curved, arcuate, or elliptical cuts, respectively, in the work piece 20 as desired. In accordance with at least one embodiment of the disclosure, the guide 115 can be at least substantially integral with the second clamping portion 102. By way of example, the guide 115 can be substantially visually indistinguishable from the second clamping portion 102, with the guide surface 105 being substantially the only visually distinguishing feature of the guide. By way of further example, the guide surface 105 can be molded, formed, routed, milled, machined, or otherwise made substantially integral with the second clamping portion 102.

In accordance with an alternative embodiment of the disclosure, the guide surface 105 can be defined on the second clamping portion 102. Alternatively, the guide 115 can be a separate component that is attached to the second clamping portion 102 such as by fastening or the like. For example, the guide 115 can be substantially in the form of a strip of milled and/or sawn material such as lumber that is fastened to the second clamping portion 102. Alternatively, for example, the guide 115 can be a strip of formed or extruded metal such as an angle, tee, channel, or the like. In accordance with at least one embodiment of the disclosure, the guide surface 105 can be substantially in the form of a wall or edge against which the saw 10 can be urged, and slid along, to provide cutting guidance and/or alignment. The guide surface 105 can be substantially perpendicular to the second clamping surface 112. However, it is to be understood that the guide surface 105 can have any of a number of possible orientations relative to the second clamping surface 112. Specifically, for example, the guide surface 105 can be oblique relative to the second clamping surface 112. Additionally, guide surface 105 can be coated or lined with any of a number of antifriction materials to facilitate sliding of the saw 10 along the guide surface.

### Bearing Surface

A bearing surface 107 can be defined on the second clamping portion 102. The bearing surface 107 can be substantially flat and smooth so as to enable the saw 10 to be easily slid across the bearing surface. The bearing surface 107 can be coated or lined with any of a number of antifriction materials to facilitate sliding of the saw 10 across the bearing surface. The bearing surface 107 can be defined on a side of the second clamping portion 102 opposite that on which the second contact surface 112 is defined. By way of example, the bearing surface 107 can be defined on the top of the second clamping portion 102 as depicted. The bearing surface 107 can be substantially parallel with the second contact surface 112. The bearing surface 107 can be substantially adjacent to, or can adjoin, the guide surface 105. The guide surface 105 can be substantially perpendicular to the bearing surface 107. Likewise, the guide 115 can be adjacent to the bearing surface 107. However, it is to be understood that the guide surface 105 can have any of a number of possible orientations relative to the bearing surface 107. For example, the guide surface 105 can be oblique relative to the bearing surface 107.

The bearing surface 107 is configured to support at least the weight of the saw 10. The bearing surface 107 can additionally support a downward force exerted by a saw operator during cutting of the work piece 20. More specifically, the saw 10 can be rested upon and/or pressed against the bearing surface 107 as the saw is slid across the bearing surface and along the guide surface 105 while cutting the work piece 20. It will be appreciated that the mass of the saw 10 weighing down against the bearing surface 107 and/or a force exerted by an operator pushing down on the saw or pushing down on the bearing surface, can provide a substantial clamping force to effectively secure the work piece 20 in place between the first clamping portion 101 and the second clamping portion 102 during cutting or sawing.

It will be further appreciated that, as mentioned above, the saw 10 can also be urged against the guide surface 105 for cutting guidance while the saw is also slid upon and/or along the bearing surface 107. The aforementioned clamping action provided by the weight of the saw 10 and/or downward exertions of a saw operator against the bearing surface 107, in conjunction with the guiding action provided by the engagement of the saw against the guide surface 105 can enable the saw operator to produce a substantially accurate and/or straight cut on the work piece 20.

### Foldable Nature of Apparatus

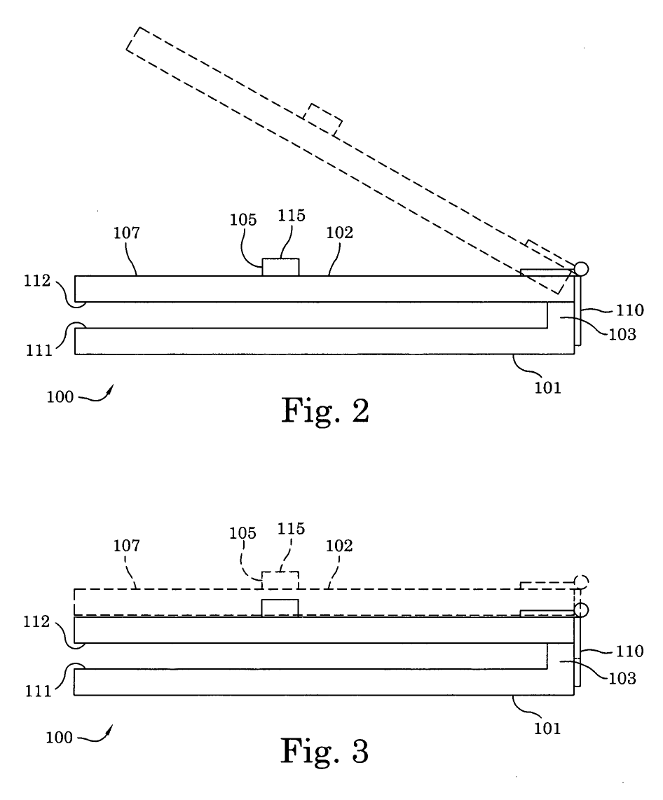

Turning now to FIG. 2, a side view is shown in which the foldable nature of the apparatus 100 is depicted. Specifically, the first clamping portion 101 and the second clamping portion 102 can be moved or folded relative to one another by way of the foldable connection 110, as shown. In other words, the first clamping portion 101 and the second clamping portion 102 can be moved or folded between a closed, or clamping, position and an or open, or loading, position. An open or loading position is indicated by the phantom lines in FIG. 2. By way of example, the apparatus 100 can be moved to an open, or loading, position to allow the work piece 20 (shown in phantom in FIG. 2) to be loaded or placed into the apparatus. After the work piece 20 is loaded into the apparatus 100, the apparatus can then be moved to a closed, or clamping, position to clamp or secure the work piece for cutting or sawing.

### Variable Spacing Feature of Apparatus

Turning now to FIG. 3, another side view is shown in which a variable spacing feature of the apparatus 100 is depicted. Specifically, the apparatus 100 can be configured such that spacing between the first clamping portion 101 and the second clamping portion 102 can be adjustable, or variable, to allow for a work piece 20 (shown in FIG. 1) having any of a number of different thicknesses. In accordance with one embodiment of the disclosure, the foldable connection 110 can be movable relative to at least one of the first clamping portion 101 and the second clamping portion 102 to provide variable spacing as is discussed in greater detail herein below. By way of example, the apparatus 100 can be variable between a small spacing position and a large spacing position. A large spacing position is indicated by the phantom lines in FIG. 3.

### Foldable Connection

As mentioned herein above, the apparatus 100 includes at least one foldable connection 110. The foldable connection 110 joins the first clamping portion 101 with the second clamping portion 102 in a foldable manner. That is, the foldable connection 110 allows the first clamping portion 101 and the second clamping portion 102 to be moved or folded between open loading positions and closed clamping positions as specifically depicted in FIG. 2.

The foldable connection 110 can have any of a number of specific forms including, but not limited to, that of a pivot, or hinge, as depicted. By way of example, the foldable connection 110 can alternatively be in the form of a strap, a strip, a chain, a belt, a plurality of hinges or hinge elements or the like. The foldable connection 110 enables the first clamping portion 101 to fold relative to the second clamping portion 102. It is to be understood that the foldable connection 110 can include any of a number of additional features and/or components that are not specifically depicted herein, including but not limited to detents, catches, latches, struts, biasing members, clamps, locks, and the like for holding the first and/or the second clamping portions 101, 102 in an open (i.e., loading) and/or closed (i.e., clamping) position.

With reference now to FIGS. 3-5, the foldable connection 110 can define a pivot line or center of rotation 117. For example, when the foldable connection 110 is in the form of a pivot, or hinge, as depicted, the pivot line or center of rotation 117 is an imaginary center line about which the hinge components pivot or rotate. The pivot line 117 can be substantially parallel with the bearing surface 107. Additionally, or alternatively, the pivot line 117 can be substantially parallel with the second clamping surface 112. By way of further example, the pivot line 117 can be substantially parallel with the guide surface 105 and/or with the guide 115.

As is mentioned herein above, the foldable connection 110 can have an adjustment feature to allow for variable spacing between the first clamping portion 101 and the second clamping portion 102. Such variable spacing between the first clamping portion 101 and the second clamping portion 102 can enable the apparatus 100 to be used with a work piece 20 having any of a range of different thicknesses. For example, when the apparatus 100 is used with a relatively thin work piece 20, the spacing between the first and second clamping portions 101, 102 can be adjusted to be relatively small. Conversely, when the apparatus 100 is used with a relatively thick work piece 20, the spacing between the first and second clamping portions 101, 102 can be adjusted to be relatively large.

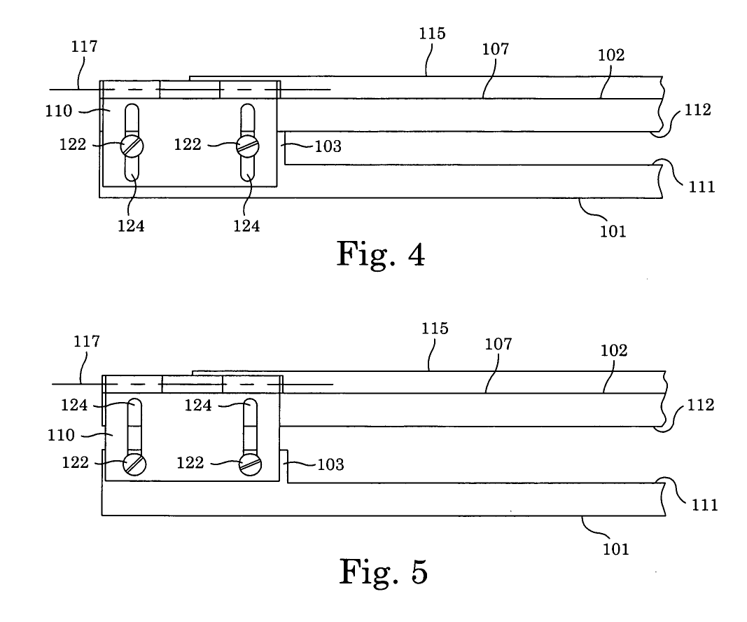

The adjustable spacing feature of the apparatus 100 in accordance with one embodiment of the disclosure is illustrated in FIGS. 4 and 5. As depicted, the foldable connection 110 can be in the form of a hinge having one or more slots 124 defined therein. At least one fastener 122, such as a screw or the like, can be employed to attach the foldable connection 110 to the first clamping portion 101 by way of a respective slot 124. With such a configuration, the fastener 122 can be positioned at a point along the length of the respective slot 124, which point corresponds to a desired spacing between the first and second clamping portions 101, 102. In this manner the foldable connection 110 can enable adjustable spacing between the first and second clamping portions 101, 102. It is to be understood that the adjustable spacing feature can be accomplished by way of any of a number of possible means, devices or features that are not specifically depicted or described herein.

### Additional Embodiment

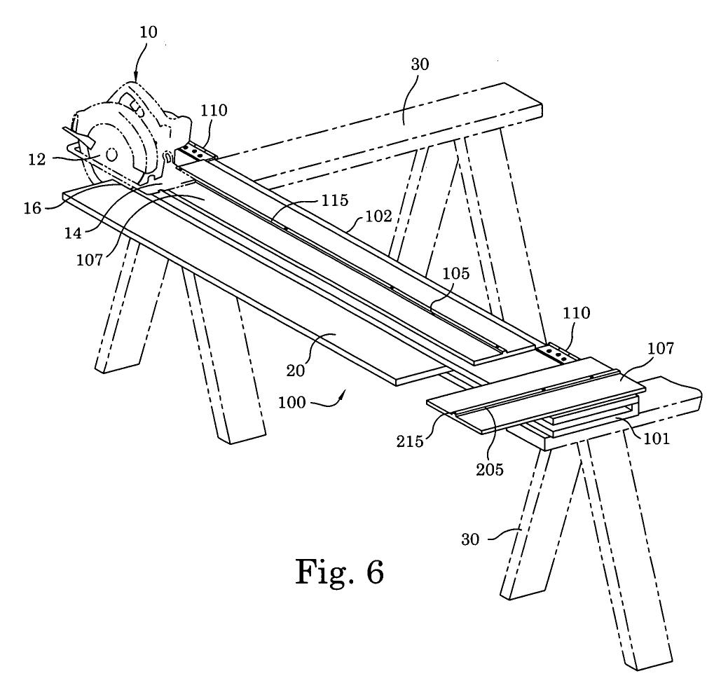

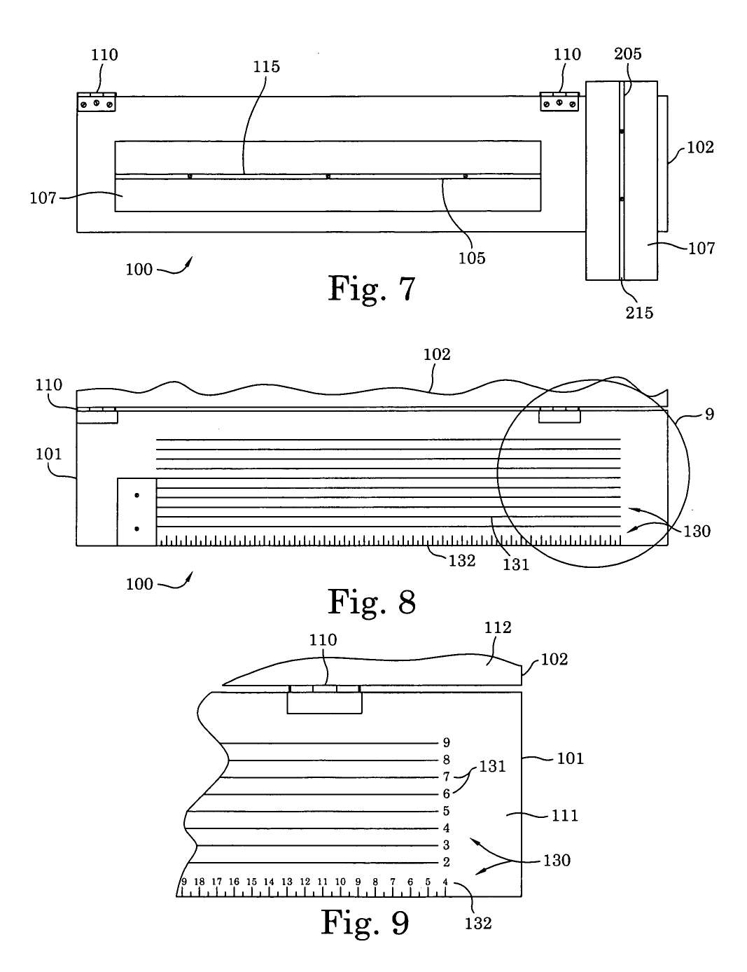

Turning to FIG. 6, a perspective view is shown in which the apparatus 100 is depicted in accordance with an alternative embodiment of the disclosure. In FIG. 7 a top view shows the apparatus 100 depicted in FIG. 6. The apparatus 100 depicted in FIG. 6 can be substantially similar to the apparatus described herein above with respect to FIGS. 1-5, with the following exceptions as noted. The apparatus 100 depicted in FIGS. 6 and 7 can have two guides 115, 215 and/or two respective guide surfaces 105, 205. More specifically, the apparatus 100 can have a first guide 115 and/or a first guide surface 105 that can be defined on the first guide. The apparatus 100 can also have a second guide 215 and/or a second guide surface 205 that can be defined on the second guide.

The second guide 215 and/or second guide surface 205 can be oriented substantially transversely relative to the first guide 115 and/or to the first guide surface 105. In this manner, the work piece 20 can be cut in two different dimensions or directions without removing the work piece from the apparatus 100. Additionally, such a configuration can accommodate both longitudinal (i.e. rip) cuts and transverse (i.e. cross) cuts of the work piece 20. By way of example, the first guide 115 and/or first guide surface 105 can be employed for making longitudinal cuts in the work piece 20, while the second guide 215 and/or second guide surface 205 can be employed for making transverse cuts in the work piece.

In accordance with at least one embodiment of the present disclosure, each of the guides 115, 215 can be in the form of an aluminum extrusion that is fastened to the second clamping portion 102, as depicted. The respective first and second guide surfaces 105, 205 can be defined on a ridge formed in the extrusion. Additionally, the bearing surface 107 can be substantially integral with one or more of the guides 115, 215, as is also depicted.

In accordance with yet another embodiment of the present disclosure, one or more of the guides 115, 215 and/or one or more of the guide surfaces 105, 205 can be adjustable with respect to its orientation relative to the other guide and/or guide surface. By way of example, the second guide 215, and thus the second guide surface 205, can be configured to adjustably pivot relative to the first guide 115 and/or the first guide surface 105. In this manner, an angle of cut of the work piece 20 can be varied as desired.

### Reference Markings

With reference now to FIG. 8, another top view shows the apparatus 100 that is depicted in FIGS. 6 and 7. The apparatus 100 as depicted in FIG. 7 is shown in a closed, or clamping, position, while the apparatus as depicted in FIG. 8 is shown in an open, or loading, position. A study of FIG. 8 reveals that the apparatus 100 can include one or more reference markings 130. The reference markings 130 can be defined on the first clamping portion 101. The reference markings 130 can include one or more first reference markings 131 as well as one or more second reference markings 132.

FIG. 9 is a detail view of the reference markings 130 depicted in FIG. 8. The first reference markings 131 can be oriented transversely relative to the second reference markings 132. With reference to FIGS. 7-9, it will be appreciated that the first reference markings 131 can be indicative of respective distances from the first guide surface 105, while the second reference markings 132 can be indicative of respective distances from the second guide surface 205.

More specifically, the first reference markings 131 can be indicative of respective distances from the cut line 16 of the saw 10 when the saw is guided by the first guide surface 105. Similarly, the second reference markings 132 can be indicative of respective distances from a cut line of the saw 10 when the saw is guided by the second guide surface 205. Accordingly, it will be appreciated that, by way of example, the first reference markings 131 can be employed to indicate the width of a work piece 20 after being cut while using the first guide surface 105, while the second reference markings 132 can be employed to indicate the length of a work piece 20 after being cut while using the second guide surface 205. In other words, the first reference markings 131 can be used to substantially measure or indicate the cut width of a work piece 20, while the second reference markings 132 can be used to substantially measure or indicate the cut length of a work piece.

### Methods Concerning Manner of Use

With reference to FIGS. 1-9, the apparatus 100 can be used in the manner described as follows. The apparatus 100 is placed on and/or secured to a suitable base/support 30. A work piece 20 to be cut is selected. The location of one or more cut lines 16 to be made to the work piece 20 can also be determined. The apparatus 100 is moved to an open or loading position by unfolding the first and second clamping portions 101, 102 relative to one another. The work piece 20 is then placed on the first clamping surface 111 of the first clamping portion 101.

The work piece 20 can be positioned relative to an appropriate reference marking 130 in order to produce a cut line 16 in the desired location on the work piece. More specifically, for example, an edge of the work piece 20 can be aligned with a selected first reference marking 131 to produce an associated width of the work piece after being cut. Alternatively and/or additionally, an end of the work piece 20 can be aligned with a selected second reference marking 132 to produce an associated length of the work piece after being cut. In accordance with at least one embodiment of the disclosure, the angle of one or more of the guides 115, 215 and/or the guide surfaces 105, 205 can be adjusted to produce a cut line 16 having a corresponding desired angle.

Once the work piece 20 is positioned on the first contact surface 111 in suitable relation to the first and/or second reference markings 131, 132, the apparatus 100 is moved to a closed or clamping position. Specifically, the closed or clamping position of the apparatus 100 can be achieved by folding the second clamping portion 102 into substantially parallel juxtaposed alignment with the first clamping portion 101 so as to clamp or sandwich the work piece 20 between the first and second clamping portions.

The spacing between the first and second clamping portions 101, 102, can be adjusted to the specific thickness of the particular work piece 20 being cut so that the first and second clamping surfaces 111, 112 are substantially parallel with and/or are in substantially full contact with the bottom and top surfaces, respectively, of the work piece. Adjustment of the foldable connections 110 to produce the desired spacing of the first and second clamping portions 101, 102 is described herein above.

Once the apparatus 100 is moved to a closed or clamping position, the saw 10 is placed on the bearing surface 107 of the second clamping portion 102 in a location appropriate for initiating a saw cut or cut line 16 in the work piece 20. The saw 10 can be allowed to weigh entirely upon the bearing surface 107 during cutting of the work piece 20. Additionally, the saw operator can lean or push on the saw 10 and/or upon the second clamping portion 102. By way of example, the saw operator can exert downward forces on the saw 10 and/or directly upon the second clamping portion 102. In this manner, the weight of the saw 10 along with additional forces exerted by the saw operator against the saw and/or directly against the second clamping portion 102 can provide a clamping force that clamps or secures the work piece 20 between the first and second clamping portions 101, 102.

Next, the saw operator starts the saw 10, and begins cutting the work piece 20 by sliding the saw along the bearing surface 107 while also urging the saw against the appropriate guide surface 105, 205. At the point shortly after initiating the saw cut, the apparatus 100, the saw 10, and the work piece 20 can appear substantially as depicted in FIG. 1 or FIG. 6, depending upon the specific embodiment of the apparatus. The saw operator continues to slide the saw 10 in a forward cutting direction while urging the saw against the appropriate guide surface 105, 205 until the cut is completed. While making the cut, the saw operator can allow the saw 10 to weigh entirely against the bearing surface 107, and the saw operator can also lean or push downward on the saw and/or directly on the second clamping portion 102 in order to provide appropriate clamping forces to securely hold the work piece 20 between the first and second clamping portions 101, 102.

In view of the above, a method for clamping a work piece 20 to be sawn using a hand-held power saw 10 includes providing a first clamping portion 101 that is foldably connected with a second clamping portion 102. The work piece 20 is placed between the first and second clamping portions 101, 102. Placing the work piece 20 between the first and second clamping portions 101, 102 can include moving or pivoting the first and second clamping portions from an open loading position to a closed clamping position.

The saw 10 can be allowed to weigh on the second clamping portion 102, thereby providing at least a portion of a clamping force to secure the work piece 20 between the first and second clamping portions for cutting. The method can also include pushing downward on the second clamping portion 102, thereby providing an additional portion of the clamping force. The saw 10 is slid upon the second clamping portion 102 while cutting the work piece 20. The saw 10 can be slid along and/or urged against a guide surface 105, 205 while cutting the work piece 20, wherein the guide surface can be defined on the second clamping portion 102. The work piece 20 can be aligned with a marking such as a reference marking 131 defined on the first clamping portion 101, as described herein above.

### Interpretation Notes

The above description has set out various features, functions, methods and other aspects of the inventions. This has been done with regard to the currently preferred embodiments thereof. Time and further development may change the manner in which the various aspects are implemented. Such aspects may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein. Also included are equivalents of the inventions which can be made without departing from the scope of concepts properly protected hereby.

I claim:

1. An apparatus for clamping a work piece to be cut with a hand-held power saw, comprising:
a first clamping portion;
a second clamping portion adapted to support the saw and forces applied thereto by an operator to thereby provide a clamping force to secure the work piece between the first and second clamping portions;
at least one foldable connection joining the first clamping portion to the second clamping portion to allow the first and second clamping portions to be moved between open loading positions and closed clamping positions; and
at least one guide attached to a clamping portion for guiding the saw to cut along a desired saw line of a work piece properly positioned between the first and second clamping portions.

2. The apparatus of claim 1, further comprising a guide surface defined on the guide and adapted to guidingly engage the saw.

3. The apparatus of claim 1, further comprising:
a guide surface defined on the guide and adapted to guidingly engage the saw; and
a marking indicative of a distance from the guide surface.

4. The apparatus of claim 1, wherein the first and second clamping portions are adapted to be moved into substantially parallel juxtaposition with one another in the closed clamping position.

5. The apparatus of claim 1, wherein the foldable connection comprises a hinge.

6. The apparatus of claim 1, wherein the foldable connection comprises a hinge that defines a pivot line, wherein the pivot line is substantially parallel with the guide.

7. The apparatus of claim 1, wherein the foldable connection is adjustable to allow a variable spacing between the first and second clamping portions.

8. An apparatus for clamping a work piece to be cut with a hand-held power saw, comprising:
a first clamping portion;
a second clamping portion adapted to support the saw and forces applied thereto by an operator to thereby provide a clamping force to secure the work piece between the first and second clamping portions;
at least one foldable connection joining the first clamping portion to the second clamping portion to allow the first and second clamping portions to be moved between open loading positions and closed clamping positions;
a first guide attached to a clamping portion for guiding the saw to cut along a first saw line of a work piece properly positioned between the first and second clamping portions; and
a second guide attached to a clamping portion for guiding the saw to cut along a second saw line of a work piece properly positioned between the first and second clamping portions.

9. The apparatus of claim 8, wherein the first guide and the second guide are obliquely oriented relative to one another.

10. The apparatus of claim 8, wherein the first guide and the second guide are substantially perpendicular to one another.

11. The apparatus of claim 8, further comprising:
a first guide surface defined by the first guide;
a second guide surface defined by the second guide;
a plurality of first markings, each indicating a respective distance from the first guide surface; and
a plurality of second markings, each indicating a respective distance from the second guide surface.

12. The apparatus of claim 8, further comprising:
a first guide surface defined by the first guide; and
a second guide surface defined by the second guide, wherein the first guide surface and the second guide surface are substantially perpendicular to one another.

13. The apparatus of claim 8, wherein the foldable connection comprises a hinge.

14. The apparatus of claim 8, wherein the foldable connection is adjustable to allow a variable spacing between the first and second clamping portions.

15. A method for clamping a work piece for being sawn using a hand-held power saw, comprising:
providing a first clamping portion foldably connected with a second clamping portion;
placing the work piece between the first and second clamping portions;
forcing the first clamping portion and the second clamping portion together, thereby securing the work piece between the first and second clamping portions for cutting.

16. The method of claim 15, further comprising placing the saw on one of the clamping portions.

17. The method of claim 15, further comprising placing the saw on one of the clamping portions, wherein forcing the first and second clamping portions together comprises pushing on the saw.

18. The method of claim 15, further comprising sliding the saw upon one of the clamping portions while cutting the work piece.

19. The method of claim 15, further comprising sliding the saw along a guide surface while cutting the work piece, wherein the guide surface is defined on one of the clamping portions.

20. The method of claim 15, further comprising aligning the work piece with a marking defined on one of the clamping portions.

21. The method of claim 15, wherein placing a work piece between the first and second clamping portions comprises moving the first and second clamping portions from an open loading position to a closed clamping position.
